(19) United States
(12) Patent Application Publication
(10) Pub. No.: US 2024/0320802 A1
(43) Pub. Date: Sep. 26, 2024

(54) IMAGE PROCESSING METHOD

(71) Applicant: GREATER SHINE LIMITED, Apia (WS)

(72) Inventors: SHIH-CHANG CHUANG, Tainan City (TW); HAO-JEN WANG, NEW TAIPEI CITY (TW)

(21) Appl. No.: 18/187,650

(22) Filed: Mar. 21, 2023

(51) Int. Cl. G06T 5/00; G06T 5/20; G06T 5/50; G06T 7/20

(52) U.S. Cl. CPC G06T 5/70; G06T 5/20; G06T 5/50; G06T 7/20; G06T 2207/20182; G06T 2207/20216

(57) ABSTRACT

The present application discloses an image processing method for deriving an edge-guided motion vector of a first pixel of a current frame. The image processing method includes: calculating similarity metrics of the first pixel according to a reference frame, wherein the similarity metrics are associated with candidate motion vectors of the first pixel, respectively; obtaining a reference motion vector of a reference pixel of the current frame; calculating penalties caused by the reference pixel according to an edge strength of the reference pixel and an edge strength of the first pixel, wherein the greater the edge strength of the reference pixel, the greater the penalties; and selecting the edge-guided motion vector from the candidate motion vectors according to the similarity metrics, the candidate motion vectors, and the penalties.

### TECHNICAL FIELD

The present disclosure relates to an image processing method, and more particularly, to an image processing method for enhancing a noise reduction process.

### DISCUSSION OF THE BACKGROUND

Using a noise reduction process can improve image quality. However, in low-light areas, reducing noise can be challenging as the noise level may be almost equal to the signal level of image data. Therefore, developing a method that leverages the noise-reduction process to enhance image quality in low-light areas has become an area of critical importance in the field of image processing.

### SUMMARY

One embodiment of the present disclosure discloses an image processing method for deriving an edge-guided motion vector of a first pixel of a current frame. The image processing method includes: calculating similarity metrics of the first pixel according to a reference frame, wherein the similarity metrics are associated with candidate motion vectors of the first pixel respectively; obtaining a reference motion vector of a reference pixel of the current frame; calculating penalties caused by the reference pixel according to an edge strength of the reference pixel and an edge strength of the first pixel, wherein the greater the edge strength of the reference pixel, the greater the penalties; and selecting the edge-guided motion vector from the candidate motion vectors according to the similarity metrics, the candidate motion vectors, and the penalties.

The image processing method optimizes the motion compensation under the guidance of edge strengths to address the limitations of the noise reduction processes using optical flow algorithms, such as motion compensated temporal filtering, in low-light conditions.

### BRIEF DESCRIPTION OF THE DRAWINGS

A more complete understanding of the present disclosure may be derived by referring to the detailed description and claims when considered in connection with the Figures, where like reference numbers refer to similar elements throughout the Figures.

FIG. 1 is a flow chart of an image processing method according to some embodiments of the present disclosure.

FIG. 2 is a schematic diagram of an image processing system according to some embodiments of the present disclosure.

FIG. 3 illustrates a video signal in the form of image frames according to some embodiments of the present disclosure.

FIG. 4 is a schematic diagram including a reference frame and a current frame of the video signal according to other embodiments of the present disclosure.

FIG. 5 is a schematic diagram of the reference frame and the current frame of the video signal according to some embodiments of the present disclosure.

### DETAILED DESCRIPTION

The following description accompanies drawings, which are incorporated in and constitute a part of this specification, and which illustrate embodiments of the disclosure, but the disclosure is not limited to the embodiments. In addition, the following embodiments can be properly integrated to complete another embodiment.

References to “one embodiment,” “an embodiment.” “exemplary embodiment.” “other embodiments.” “another embodiment,” etc. indicate that the embodiment(s) of the disclosure so described may include a particular feature, structure, or characteristic, but not every embodiment necessarily includes the particular feature, structure, or characteristic. Further, repeated use of the phrase “in the embodiment” does not necessarily refer to the same embodiment, although it may.

In order to make the present disclosure completely comprehensible, detailed steps and structures are provided in the following description. Obviously, implementation of the present disclosure does not limit special details known by persons skilled in the art. In addition, known structures and steps are not described in detail, so as not to unnecessarily limit the present disclosure. Preferred embodiments of the present disclosure will be described below in detail. However, in addition to the detailed description, the present disclosure may also be widely implemented in other embodiments. The scope of the present disclosure is not limited to the detailed description, and is defined by the claims.

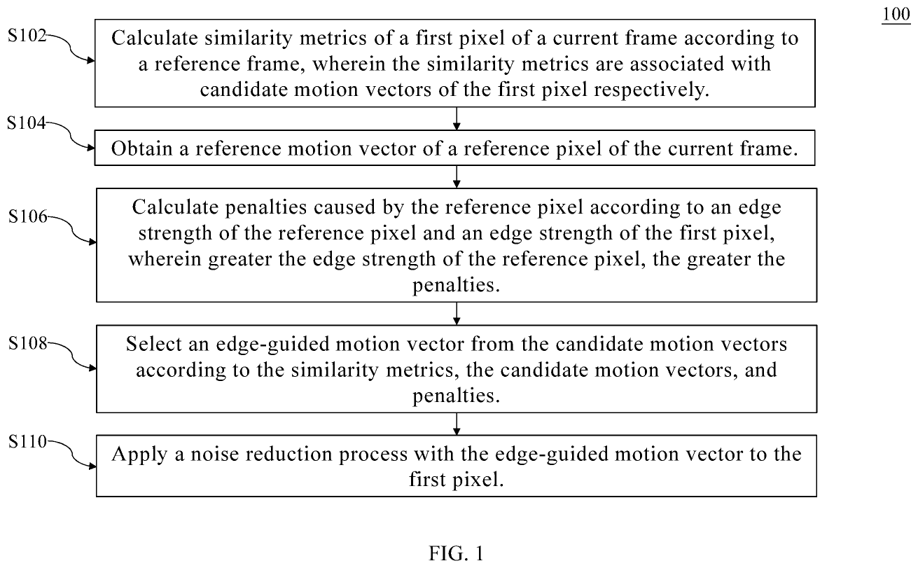

FIG. 1 is a flow chart of an image processing method 100 according to some embodiments of the present disclosure. The image processing method 100 can be adopted to enhance a noise reduction process. In some embodiments, the noise reduction process is based on motion compensated temporal filtering (MCTF).

Typically, edges in an image are more distinguishable than other textures of the image, even if the edges are in a low-light area. The image processing method 100 takes advantage of such distinguishability of edges to estimate a motion vector by considering an influence caused by the edges when correcting errors of the motion compensated temporal filtering in low-light conditions. Consequently, the image processing method 100 can obtain a better motion vector (hereinafter referred to as an edge-guided motion vector MV) to enhance the noise reduction process.

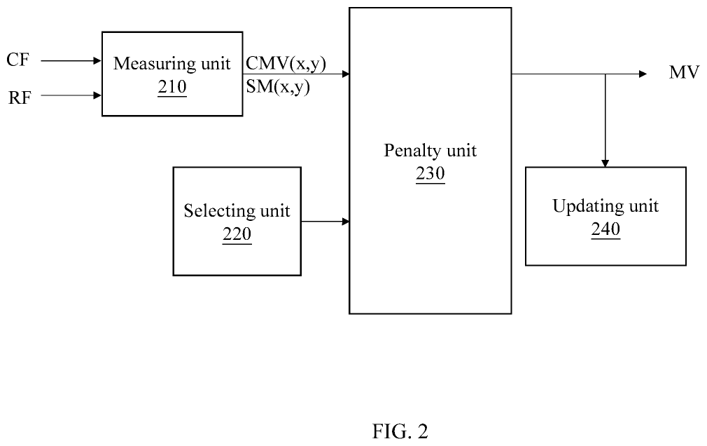

The image processing method 100 includes operations S102, S104, S106, S108 and S110. To facilitate understanding, the image processing method 100 is described with respect to FIG. 2 to FIG. 5 and the reference numerals in these drawings.

FIG. 2 is a schematic diagram of an image processing system 200 according to some embodiments of the present disclosure. In the present embodiment, the image processing system 200 can be configured to perform the image processing method 100. The image processing system 200 includes a measuring unit 210, a selecting unit 220, a penalty unit 230, and an updating unit 240.

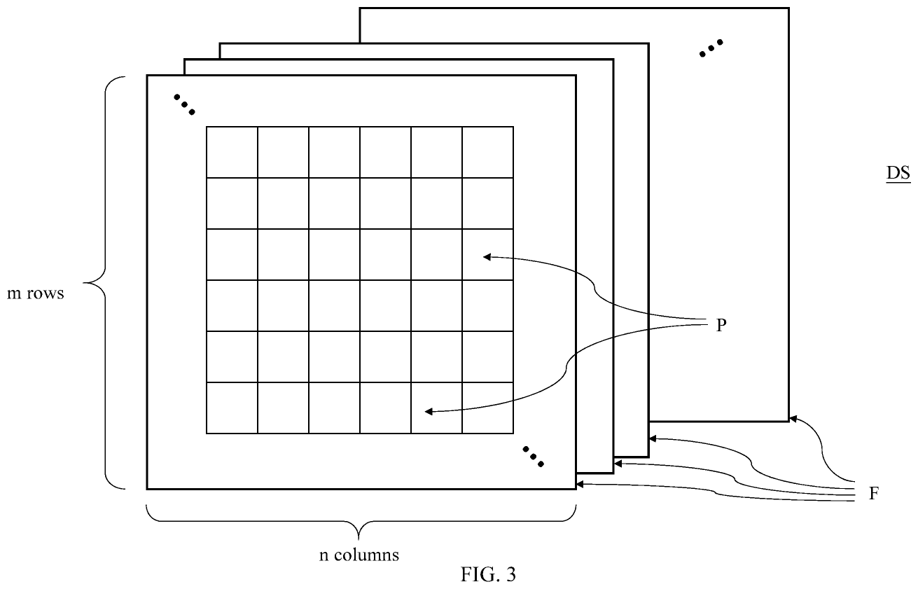

In some embodiments, the image processing system 200 is configured to process a video signal DS having a plurality of image frames F in sequence as illustrated in FIG. 3. Each of the frames F includes a plurality of pixels P arranged in m rows and n columns, in which n and m are positive integers.

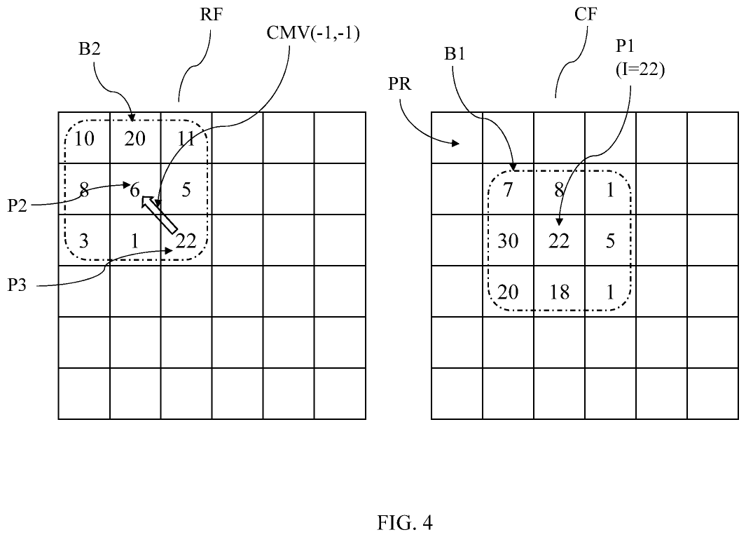

FIG. 4 is a schematic diagram of a current frame CF and a reference frame RF of the video signal DS according to some embodiments of the present disclosure. The reference frame RF is a frame prior to and adjacent to the current frame CF.

In some embodiments, the image processing system 200 performs the image processing method 100 on every pixel P in each of the frames F. In other embodiments, the image processing system 200 performs the image processing method 100 on a portion of the pixels P in the frames F. For ease of comprehension, the disclosure below describes the image processing method 100 being performed on one pixel in the current frame CF, where the pixel being processed in the current frame CF is designated as the pixel P1.

The current frame CF and the reference frame RF are illustrated using a 6 by 6 matrix. However, it should be noted that the present disclosure is not limited to the number of rows and columns shown in FIG. 4.

In operation S102, the measuring unit 210 is configured to calculate the similarity metrics SM(x,y) of the pixel P1 according to the reference frame RF, where the similarity metrics SM(x,y) are associated with the candidate motion vectors CMV(x,y) of the pixel P1, respectively. In the present disclosure, for every symbol that includes (x,y), x and y are integers. In some embodiments, each of the similarity metrics SM(x,y) of the pixel P1 is calculated from the sum of absolute differences (SAD) between one block of the current frame CF and one block of the reference frame RF on a per-pixel basis. The block of the current frame CF includes the pixel P1. In some embodiments, the pixel P1 is at the center of the block of the current frame CF. In some embodiments, each of the similarity metrics SM(x,y) of the pixel P1 corresponds to a candidate motion vector CMV(x,y) used for motion compensation that provides an offset from the coordinate position in the current frame CF to the coordinate in the reference frame RF. For instance, suppose that the pixel P1 has the coordinate (x₀, y₀), and the candidate motion vector CMV(x,y) represents a vector (x,y) that points from the coordinate of (x₀, y₀) to the coordinate of (x₀+x,y₀+y). In this case, the corresponding similarity metrics SM(x,y) can be calculated by:

$$S M ( x , y ) = {\sum }_{i = {x}_{0} - \frac{{N - 1}_{}}{2}}^{{x}_{0} + \frac{N - 1}{2}} {\sum }_{j = {y}_{0} - \frac{{N - 1}_{}}{2}}^{{y}_{0} + \frac{N - 1}{2}} \vert {I}_{current} ( i , j ) - {I}_{reference} ( x + i , y + j ) \vert . \qquad ( 1 )$$

In expression (1), N is one dimension of the block and the block has a size of N×N pixels, I_{current}(i, j) represents the pixel value at the coordinate (i, j) of the current frame CF, I_{reference}(x+i, y+j) represents the pixel value at the coordinate (x+i, y+j) of the reference frame RF, and the similarity metric SM(x, y) can be the sum of absolute differences between the block in the current frame CF and the block, offset by the motion vector (x,y), in the reference frame RF.

In FIG. 4, a similarity metric SM(−1−1) (for one of the candidate motion vectors, CMV(−1−1)) of the pixel P1 is calculated between a block B1 of the current frame CF and a block B2 of the reference frame RF. Each of the blocks B1 and B2 has 9 pixels (N=3), and each pixel has a pixel value as shown in FIG. 4. The similarity metric SM(x, y) that corresponds to the candidate motion vector CMV(x, y) is calculated from the SAD as described above. In the example of the candidate motion vector CMV(−1, 1), the similarity metric SM(−1,−1) is calculated as follows:

$$S M ( - 1 , - 1 ) = \vert 10 - 7 \vert + \vert 20 - 8 \vert + \vert 11 - 1 \vert + \vert 8 - 30 \vert + \vert 6 - 22 \vert + \vert 5 - 5 \vert + \vert 3 - 20 \vert + \vert 1 - 18 \vert + \vert 22 - 1 \vert = 118 .$$

In operation S104, the penalty unit 230 is configured to obtain a reference motion vector of a reference pixel PR in the current frame CF. In some embodiments, the reference pixel PR can be selected from the pixels that have been processed. In some embodiments, the reference pixel PR is at the a^{th} row and the b^{th} column, and the pixel P1 is at the c^{th} row and the d^{th} column, in which a<c≤m and b<d≤n. In some embodiments, the selecting unit 220 is configured to select the reference pixel PR from the current frame CF according to some fixed patterns. For example, c is always equal to a+2, and d is always equal to b+2. In some embodiments, the selecting unit 220 selects the reference pixel in a random manner. For example, c is equal to a+e, d is equal to b+f, and e and f are random positive integers. In some embodiments, there might be one or more reference pixels, and the selecting unit 220 can decide on the best one among them according to the propagated edge information and the patch similarity. This results in obtaining the reference motion vector RMV.

In operation S106, the penalty unit 230 is configured to calculate penalties PNT(x,y) caused by the reference pixel PR according to the edge strength Er of the reference pixel PR and the edge strength Ep of the pixel P1. The penalties PNT(x,y) reflect the influence caused by edges (if any). In some scenarios, such as in low-light scenes, relying solely on SAD for determining motion vectors may result in inaccuracies due to noise, as discussed earlier. To improve the accuracy of motion vector determination, the method 100 also evaluates and considers the influence of edges, which can be represented by the edge strength. In some embodiments, the edge strength indicates the result of edge detection performed on a pixel. More specifically, it represents the probability of edges existing on the pixel. A higher value of edge strength indicates a higher probability of edges existing on the pixel. Furthermore, when the probability of edges existing on the reference pixel PR is higher, it may imply that the pixel value and motion vector of the reference pixel PR are more reliable. In such a case, even if a candidate motion vector has the smallest similarity metric, it may not be the correct motion vector. Instead, a candidate motion vector that is closer (or more similar) to the motion vector of the reference pixel PR may be considered the correct motion vector, i.e., the edge-guided motion vector.

That is, when determining the motion vector of the pixel P1, the present disclosure can further consider the influence caused by the edge on the reference pixel PR and the motion vector of the reference pixel PR. In the present embodiment, the penalty PNT(x,y) is used to quantify the influence of the edge and the motion vector of the reference pixel PR. Generally, the greater the difference between the candidate motion vector CMV(x,y) and the motion vector of the reference pixel PR, and the higher the edge strength Er of the reference pixel PR, the greater the penalties PNT(x,y) may cause to the candidate vector CMV(x,y).

In operation S108, the penalty unit 230 is configured to select the edge-guided motion vector MV from the candidate motion vectors CMV(x,y) according to the similarity metrics SM(x,y), the candidate motion vectors CMV(x,y), and the penalties PNT(x,y). The edge-guided motion vector MV is determined by expressions (2) and (3):

$$∃ ( {x}^{′} , {y}^{′} ) : arg {min}_{{x}^{′} , {y}^{′}} [ S M ( {x}^{′} , {y}^{′} ) + P N T ( {x}^{′} , {y}^{′} ) ] ; \qquad ( 2 )$$

$$and$$

$$M V = C M V ( {x}^{′} , {y}^{′} ) . \qquad ( 3 )$$

The right side of expression (2) represents an effective similarity metric that includes the effect of original similarity metric SM(x′,y′) and the effect of edges (i.e., the penalty(x′,y′)). The penalty unit 230 determines a candidate motion vector CMV(x′,y′) that minimizes expression (2) among the candidate motion vectors CMV(x,y), and selects the candidate motion vector CMV(x′,y′) as the edge-guided motion vector MV.

In the present embodiment, each of the penalties can be determined by the weighting factor, the absolute difference between the reference motion vector and a respective one of the candidate motion vectors, the constant γ, and the standard deviation T associated with the pixel P1. The penalty can be represented by expression (4)

$$P N T ( x , y ) = γ \cdot T \cdot A B D ( x , y ) \cdot W . \qquad ( 4 )$$

PNT(x,y) stands for the penalty with respect to the candidate motion vector CMV(x, y). ABD(x,y) represents the absolute value of the difference between the reference motion vector and the candidate motion vector CMV(x,y). ABD(x,y) is used to measure the similarity between the candidate motion vector CMV(x,y) and the reference motion vector.

In some embodiments, the standard deviation T can be the standard deviation of pixel values within block B1, and can be utilized to normalize the penalty based on the SAD of the candidate motion vector CMV(x,y). The constant γ is configured to control the weight of the penalty PNT(x,y). In some embodiments, the constant γ can be set to a value between 0 and 1. In other embodiments, for brevity, the constant γ and the standard deviation T can both be set to 1, regardless of the standard deviation of the similarity metrics.

As mentioned above, the penalty is associated with the edge strength. In expression (4), W stands for the effect of the edge strength. Typically, since the edge strength is directionally dependent, it should be calculated based on a selected direction. For example, when a vertical edge crosses a pixel, the edge strength in the horizontal direction of the pixel is greater than the edge strength in the vertical direction because the vertical edge is much more distinguishable from a horizontal perspective than from a vertical perspective.

Accordingly, the weighting factor and each of the penalties PNT(x,y) can be anisotropic and can be divided into two portions related to two mutually orthogonal directions. Therefore, the penalties PNT(x,y) are calculated based on two orthogonal and independent directions. For ease of understanding, the subscript X represents the component in the first direction (e.g., the horizontal direction), and the subscript Y represents the component in the second direction (e.g., the vertical direction). PNT(x,y) in expression (4) can be expanded by expression (5):

$$P N T ( x , y ) = γ \cdot T \cdot [ A B {D}_{X} ( x , y ) \cdot {W}_{X} + A B {D}_{Y} ( x , y ) \cdot {W}_{Y} ] . \qquad ( 5 )$$

In expression (5), ABD_{X}(x,y) stands for the absolute difference in the first direction, ABD_{Y}(x,y) stands for the absolute difference in the second direction, the sub-weighting factor W_{X} stands for the weighting factor W in the first direction, and the sub-weighting factor W_{Y} stands for the weighting factor W in the second direction.

The penalty unit 230 is configured to calculate the absolute differences, each of which is calculated from the absolute value of the difference between the reference motion vector and a respective one of the candidate motion vectors. The penalty unit 230 obtains the candidate motion vectors from the measuring unit 210 and calculates the absolute differences in the two directions by:

$$A B {D}_{X} ( x , y ) = \vert R M {V}_{X} - C M {V}_{X} ( x , y ) \vert ; \qquad ( 6 )$$

$$and$$

$$A B {D}_{Y} ( x , y ) = \vert R M {V}_{Y} - C M {V}_{Y} ( x , y ) \vert . \qquad ( 7 )$$

RMV_{X} and RMV_{Y} represent the x and y components of the reference motion vector. Likewise, CMV_{X}(x,y) and CMV_{Y}(x,y) respectively stand for the x and y components of the candidate motion vector.

The weighting factor, W, depends on several variables: the edge strength Er, the edge strength Ep, the confidence value Cpr of the reference pixel PR, and the absolute difference between the pixel value Ip of the pixel P1 and the pixel value Ir of the reference pixel PR. Similarly, the edge strength Er, the edge strength Ep, and the confidence value Cpr are anisotropic, and these variables can be divided into two portions designated by the subscripts X and Y, respectively. Therefore, the weighting factor W can be expressed as follows:

$${W}_{X} = MAX ( ( {Er}_{X} - {Ep}_{X} ) , 0 ) \cdot MAX ( ( {Cpr}_{X} - {Ep}_{X} ) , 0 ) \cdot MAX ( ( C - \vert Ir - Ip \vert ) , 0 ) ; \qquad ( 8 )$$

$$and$$

$${W}_{Y} = MAX ( ( {Er}_{Y} - {Ep}_{Y} ) , 0 ) \cdot MAX ( ( {Cpr}_{Y} - {Ep}_{Y} ) , 0 ) \cdot MAX ( ( C - \vert Ir - Ip \vert ) , 0 ) . \qquad ( 9 )$$

As shown in expressions (8) and (9), the penalty unit 230 is configured to set the weighting factors W_{X} and W_{Y} based on three conditions. The first condition is related to the edge strength Er (including Er_{X} and Er_{Y}) and the edge strength Ep (including Ep_{X} and Ep_{Y}). The second condition is related to the confidence value Cpr (including Cpr_{X} and Cpr_{Y}) and the edge strength Ep. The third condition is related to the pixel value Ip and the pixel value Ir. Both expressions (8) and (9) must consider these three conditions, and the calculations in expressions (8) and (9) are similar. To simplify the description, only the components in the first direction (denoted by subscript X) are explained below.

The first condition is evaluated by comparing the edge strength Er_{X} to the edge strength Ep_{X}. If the edge strength Er_{X} is greater than the edge strength Ep_{X}, the penalty unit 230 sets the value of the first condition as Er_{X} minus Ep_{X}. If the edge strength Er_{X} is not greater than the edge strength Ep_{X}, the penalty unit 230 sets the weighting factors W_{X} to 0.

The edge strength Ep_{X} and the edge strength Er_{X} represent the probability of an edge existing on the pixel P1 and the reference pixel PR, respectively, in the first direction. If the edge strength Er_{X} is greater than the edge strength Ep_{X}, it indicates that there is a stronger or clearer edge on the reference pixel PR than on the pixel P1 in the first direction. In this case, the penalty unit 230 obtains a higher sub-weighting factor W_{X} to increase the influence of the reference motion vector in the first direction while selecting the edge-guided motion vector MV. In contrast, if the edge strength Ep_{X} is greater than the edge strength Er_{X}, it means that the pixel P1 has a stronger edge than the reference pixel PR. Therefore, the penalty unit 230 need not consider the influence caused by the edge (if any) on the reference pixel PR.

In some embodiments, the penalty unit 230 uses a Sobel filter to calculate the edge strength Er_{X} and the edge strength Ep_{X}. However, the present disclosure is not limited to the Sobel filter. Various approaches to obtaining edge strengths are within the scope of this disclosure.

Regarding the second condition, the penalty unit 230 compares the confidence value Cpr_{X} of the reference pixel PR to the edge strength Ep_{X} of the pixel P1. If the confidence value Cpr_{X} is greater than the edge strength Ep_{X}, the penalty unit 230 sets a positive value for the second condition by subtracting the edge strength Ep_{X} from the confidence value Cpr_{X}. In contrast, if the confidence value Cpr_{X} is not greater than the edge strength Ep_{X}, the penalty unit 230 sets the sub-weighting factors W_{X} to 0.

In some embodiments, the confidence value Cpr_{X} represents the effect that the reference pixel PR is affected by an edge that is not located on it in the first direction. In other words, the confidence value Cpr_{X} reflects an edge strength propagated from another pixel of the current frame CF to the reference pixel PR along the first direction. When the confidence value Cpr_{X} is greater, it means that the edge-guided motion vector of the reference pixel PR is generated while taking into account a stronger influence from another edge that is not located on the reference pixel PR. When the confidence value Cpr_{X} is smaller, it means that the edge-guided motion vector of the reference pixel PR is generated while considering a greater influence from the edge strength Ep_{X} of the pixel P1. Therefore, if the confidence value Cpr_{X} is greater than the edge strength Ep_{X}, the penalty unit 230 generates a higher sub-weighting factor W_{X} to increase the influence of the reference motion vector in the first direction while selecting the edge-guided motion vector MV. In contrast, if the confidence value Cpr_{X} is not greater than the edge strength Ep_{X}, this indicates the pixel P1 has a stronger edge on it than the other edge, and the penalty unit 230 need not consider the influence caused by the other edge.

Regarding the third condition, the penalty unit 230 compares the predetermined constant C to the absolute difference between the pixel value Ip of the pixel P1 and the pixel value Ir of the reference pixel PR. If the predetermined constant C is greater than the absolute difference between the pixel value Ip and the pixel value Ir, the penalty unit 230 assigns a value to the third condition that is equal to the predetermined constant C minus the absolute difference between the pixel value Ip and the pixel value Ir. If the predetermined constant C is not greater than the absolute difference between the pixel value Ip and the pixel value Ir, the penalty unit 230 sets the sub-weighting factors W_{X} to 0.

In some embodiments, the predetermined constant C is substantially equal to the average noise level among the pixels. In some embodiments, the third condition is used to determine whether there is a strong edge between the pixel P1 and the reference pixel PR. If the predetermined constant C is greater than the absolute difference between the pixel value Ip and the pixel value Ir, it means that there is no strong edge between the pixel P1 and the reference pixel PR. In this situation, the penalty unit 230 should rely more on the reference motion vector in the first direction when calculating the sub-weighting factor W_{X} for selecting the edge-guided motion vector MV. This is because the influence of the reference motion vector has already propagated smoothly to the pixel P1. In contrast, when the absolute difference between the pixel value Ip and the pixel value Ir is greater than the predetermined constant C, it means that a strong edge exists between the pixel P1 and the reference pixel PR but not within the pixel P1 and not within the reference pixel PR. Therefore, none of the edge strength Ep_{X}, the edge strength Er_{X}, and the confidence value Cpr_{X} should be taken into consideration when selecting the edge-guided motion vector MV.

In some embodiments, the first condition has a more dominant influence than the second and the third conditions on the selection of the edge-guided motion vector MV. Therefore, the expressions (8) and (9) may consider only the first condition, and the values of the other two conditions are set to 1 to simplify the calculation. In other embodiments, the first condition and the second condition have more dominant influences than the third condition on the selection of the edge-guided motion vector MV. Thus, in such embodiments, the expressions (8) and (9) consider both the first and the second conditions, and the value of the third condition is set to 1 to simplify the calculation.

After selecting the edge-guided motion vector MV, the updating unit 240 sets the confidence value Cp_{X} of the pixel P1 in the first direction. If the edge strength Ep_{X} of the pixel P1 is greater than the confidence value Cpr_{X} of the reference pixel PR, the updating unit 240 assigns the edge strength Ep_{X} to the confidence value Cp_{X}. Otherwise, the confidence value Cp_{X} of the pixel P1 is set to a weighted sum of the edge strength Ep_{X} and the confidence value Cpr_{X} of the reference pixel PR, which is represented by an expression (10):

$${Cp}_{X} = {Cpr}_{X} \cdot α + {Ep}_{X} \cdot ( 1 - α ) . \qquad ( 10 )$$

In expression (10), α is a weight.

Similarly, the updating unit 240 is configured to set the confidence value Cp_{Y} of the pixel P1 in the second direction using expression (11).

$${Cp}_{Y} = {Cpr}_{Y} \cdot α + {Ep}_{Y} \cdot ( 1 - α ) . \qquad ( 11 )$$

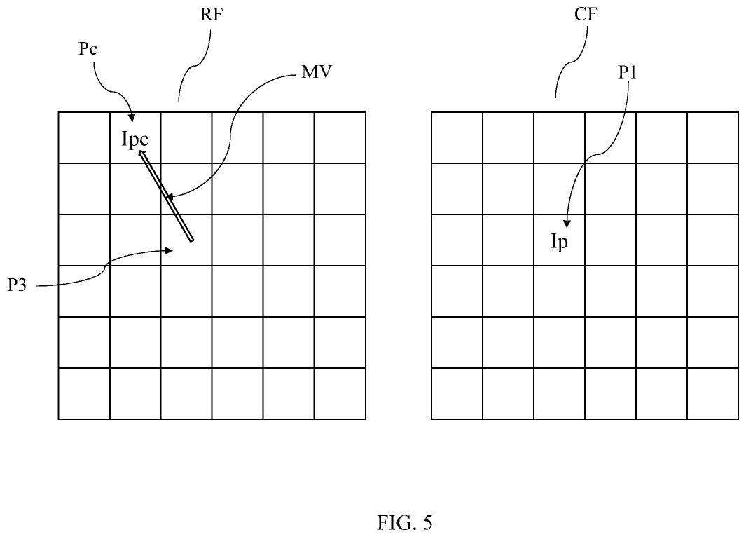

In operation S110, the image processing system 200 is configured to apply the noise reduction process with the edge-guided motion vector MV to the pixel P1. In some embodiments, the image processing system 200 locates a candidate pixel Pc in the reference frame RF using the edge-guided motion vector MV. Referring to FIG. 5, the edge-guided motion vector MV points from a pixel (the pixel P3) in the reference frame RF that has the same coordinate position as the pixel P1 in the current frame CF to the candidate pixel Pc. The image processing system 200 then performs a weighted averaging on the pixel value Ipc of the candidate pixel Pc and the pixel value Ip of the pixel P1 to update the pixel value Ip of the pixel P1.

Although the present disclosure and its advantages have been described in detail, it should be understood that various changes, substitutions and alterations can be made herein without departing from the spirit and scope of the disclosure as defined by the appended claims. For example, many of the processes discussed above can be implemented in different methodologies and replaced by other processes, or a combination thereof.

Moreover, the scope of the present application is not intended to be limited to the particular embodiments of the process, machine, manufacture, composition of matter, means, methods and steps described in the specification. As one of ordinary skill in the art will readily appreciate from the present disclosure, processes, machines, manufacture, compositions of matter, means, methods or steps, presently existing or later to be developed, that perform substantially the same function or achieve substantially the same result as the corresponding embodiments described herein, may be utilized according to the present disclosure. Accordingly, the appended claims are intended to include within their scope such processes, machines, manufacture, compositions of matter, means, methods and steps.

What is claimed is:

1. An image processing method for deriving an edge-guided motion vector of a first pixel of a current frame, comprising:
calculating a plurality of similarity metrics of the first pixel according to a reference frame, wherein the similarity metrics are associated with a plurality of candidate motion vectors of the first pixel, respectively;
obtaining a reference motion vector of a reference pixel of the current frame;
calculating a plurality of penalties caused by the reference pixel according to an edge strength of the reference pixel and an edge strength of the first pixel, wherein the greater the edge strength of the reference pixel, the greater the penalties; and
selecting the edge-guided motion vector from the candidate motion vectors according to the similarity metrics, the candidate motion vectors, and the penalties.

2. The image processing method of claim 1, wherein calculating the plurality of penalties comprises:
calculating a weighting factor of the reference pixel according to the edge strength of the reference pixel and the edge strength of the first pixel;
calculating a plurality of absolute differences each of which is calculated from an absolute value of a difference between the reference motion vector and a respective one of the candidate motion vectors; and
computing the penalties each of which is based on a product by multiplying the weighting factor and a respective one of the absolute differences.

3. The image processing method of claim 2, wherein calculating the weighting factor of the reference pixel comprises:
calculating a first sub-weighting factor of the reference pixel in a first direction; and
calculating a second sub-weighting factor of the reference pixel in a second direction,
wherein the second direction is orthogonal to the first direction, and
wherein each of the penalties is mainly determined by a sum of two products, one of the two products being the first sub-weighting factor multiplied by the respective one of the absolute differences in the first direction and the other of the two products being the second sub-weighting factor multiplied by the respective one of the absolute differences in the second direction.

4. The image processing method of claim 3, wherein calculating the first sub-weighting factor of the reference pixel comprises:
comparing the edge strength of the first pixel in the first direction to the edge strength of the reference pixel in the first direction;
when the edge strength of the first pixel in the first direction is greater than the edge strength of the reference pixel in the first direction, setting the first sub-weighting factor to 0; and
when the edge strength of the first pixel in the first direction is not greater than the edge strength of the reference pixel in the first direction, setting the first sub-weighting factor equal to the edge strength of the reference pixel in the first direction minus the edge strength of the first pixel in the first direction.

5. The image processing method of claim 4, wherein calculating the first sub-weighting factor of the reference pixel further comprises:
comparing the edge strength of the first pixel in the first direction to a confidence value of the reference pixel in the first direction;
when the edge strength of the first pixel in the first direction is greater than the confidence value of the reference pixel in the first direction, setting the first sub-weighting factor to 0; and
when the edge strength of the first pixel in the first direction is not greater than the edge strength of the reference pixel in the first direction, and the edge strength of the first pixel in the first direction is not greater than the confidence value of the reference pixel in the first direction, updating the first sub-weighting factor by multiplying the edge strength of the reference pixel in the first direction minus the edge strength of the first pixel in the first direction by the confidence value of the reference pixel in the first direction minus the edge strength of the first pixel in the first direction.

6. The image processing method of claim 5, wherein calculating the first sub-weighting factor of the reference pixel further comprises:
comparing a predetermined constant to an absolute difference between a pixel value of the first pixel and a pixel value of the reference pixel;
when the absolute difference between the pixel value of the first pixel and the pixel value of the reference pixel is greater than the predetermined constant, setting the first sub-weighting factor to 0; and
when the edge strength of the first pixel in the first direction is not greater than the edge strength of the reference pixel in the first direction, the edge strength of the first pixel in the first direction is not greater than the confidence value of the reference pixel in the first direction, and the absolute difference between the pixel value of the first pixel and the pixel value of the reference pixel is not greater than the predetermined constant, updating the first sub-weight factoring by multiplying the edge strength of the reference pixel in the first direction minus the edge strength of the first pixel in the first direction, the confidence value of the reference pixel in the first direction minus the edge strength of the first pixel in the first direction, and the predetermined constant minus the absolute difference between the pixel value of the first pixel and the pixel value of the reference pixel.

7. The image processing method of claim 5, wherein the confidence value of the reference pixel in the first direction reflects an edge strength propagated from another pixel of the current frame to the reference pixel along the first direction.

8. The image processing method of claim 5, wherein calculating the weighting factor of the reference pixel further comprises:
when the edge strength of the first pixel in the first direction is greater than the confidence value of the reference pixel in the first direction, setting a confidence value of the first pixel in the first direction to the edge strength of the first pixel in the first direction; and
when the edge strength of the first pixel in the first direction is not greater than the confidence value of the reference pixel in the first direction, setting the confidence value of the first pixel in the first direction to a weighted sum of the edge strength of the first pixel in the first direction and the confidence value of the reference pixel in the first direction.

9. The image processing method of claim 3, wherein calculating the second sub-weighting factor of the reference pixel comprises:
comparing the edge strength of the first pixel in the second direction to the edge strength of the reference pixel in the second direction;
comparing the edge strength of the first pixel in the second direction to a confidence value of the reference pixel in the second direction;
comparing a predetermined constant to an absolute difference between a pixel value of the first pixel and a pixel value of the reference pixel;
when the edge strength of the first pixel in the second direction is greater than the edge strength of the reference pixel in the second direction, the edge strength of the first pixel in the second direction is greater than the confidence value of the reference pixel in the second direction, or the absolute difference between the pixel value of the first pixel and the pixel value of the reference pixel is greater than the predetermined constant, setting the second sub-weighting factor to 0; and
when the edge strength of the first pixel in the second direction is not greater than the edge strength of the reference pixel in the second direction, the edge strength of the first pixel in the second direction is not greater than the confidence value of the reference pixel in the second direction, and the absolute difference between the pixel value of the first pixel and the pixel value of the reference pixel is not greater than the predetermined constant, setting the second sub-weighting factor to a product by multiplying the edge strength of the reference pixel in the second direction minus the edge strength of the first pixel in the second direction, the confidence value of the reference pixel in the second direction minus the edge strength of the first pixel in the second direction, and the predetermined constant minus the absolute difference between the pixel value of the first pixel and the pixel value of the reference pixel.

10. The image processing method of claim 2, wherein each of the penalties is computed on a basis of multiplying a constant, a standard deviation associated with the first pixel, the respective one of the absolute differences, and the weighting factor.

11. The image processing method of claim 2, wherein selecting the edge-guided motion vector from the candidate motion vectors further comprises:
adding the similarity metrics and the penalties, respectively, to get a plurality of sums each of which is computed by adding a respective one of the similarity metrics and a respective one of the penalties;
finding a minimum of the sums; and
choosing one of the candidate motion vectors for which the sums attain the minimum such that the chosen candidate motion vector is the edge-guided motion vector.

12. The image processing method of claim 1, wherein the edge strength of the first pixel and the edge strength of the reference pixel are calculated using a Sobel filter.

13. The image processing method of claim 1, wherein each of the similarity metrics is calculated from a sum of absolute differences (SAD) between a block of the current frame and a block of the reference frame on a per-pixel basis.

14. The image processing method of claim 1, further comprising:
applying a noise reduction process with the edge-guided motion vector to the first pixel in the current frame.

15. The image processing method of claim 14, wherein applying the noise reduction process comprises:
locating a second pixel in the reference frame by the edge-guided motion vector; and
weighted averaging a pixel value of the second pixel and a pixel value of the first pixel to update the pixel value of the first pixel in the current frame.

16. The image processing method of claim 14, wherein the noise reduction process is based on a motion compensated temporal filtering (MCTF).
